(19) United States
(12) Patent Application Publication
(10) Pub. No.: US 2017/0303563 A1
(43) Pub. Date: Oct. 26, 2017

(54) Delicious Garlic shakes and smoothies

(71) Applicant: Joe Ann Aiken, Ladson, SC (US)

(72) Inventor: Joe Ann Aiken, Ladson, SC (US)

(21) Appl. No.: 15/731,052

(22) Filed: Apr. 11, 2017

Related U.S. Application Data
(60) Provisional application No. 62/321,810, filed on Apr. 13, 2016.

(51) Int. Cl. A23L 2/02; A23L 2/38

(52) U.S. Cl. CPC A23L 2/02; A23L 2/38; A23V 2200/30

(57) ABSTRACT

These delicious shakes or smoothies, has the active compound called allicin, which comes from the garlic. Allicin is the key ingredient for helping to lower our metabolic risk factors. This invention could possibly be a natural substitute for garlic supplements, and Statin drugs. This invention could aide in helping regulate high blood pressure, high low-density lipoprotein (LDL), heart disease, diabetes, and strokes. This invention will make it easier to consume garlic in the raw, while contributing to optimum health.

### CROSS REFERENCE TO RELATED APPLICATION

This application claims the benefits of U.S. provisional application No. 62/321,810, filed Apr. 13, 2016, the disclosure of which is incorporated herein by reference.

### STATEMENT REGARDING FEDERALLY SPONSORED RESEARCH OR DEVELOPMENT

“Not Applicable”

### BACKGROUND OF INVENTION

This invention relates in general to the synthetic supplements and statin drugs used to help lower high low-density lipoprotein (LDL). High low-density lipoprotein can affect ones, circulatory and digestive systems, contributing to Metabolic Syndrome. My invention will offer an easy natural and inexpensive alternative to statins and garlic supplements.

“Metabolic Syndrome is a cluster of conditions increased by high blood pressure, high blood sugar, excess body fat around the waist, and abnormal cholesterol or triglyceride levels—that occur together, increasing your risk of heart disease, stroke and diabetes”.

www.mayoclinic.org

“Although it was only identified less than 20 years ago, Metabolic Syndrome is as widespread as pimples and the common cold. According to the American Heart Association, 47 million Americans have it. That's almost a staggering one out of every six people. The syndrome runs in families and is more common among African-Americans, Hispanics, Asians, and Native Americans”. The risks of developing metabolic syndrome increases as you age”.

www.webmd.com

According to the American Diabetes Association, “29 million people in the United States (9.3 percent) have diabetes. 1.7 million people age 20 years or older were newly diagnosed with diabetes in 2012”.

According to the Center for Disease Control and Prevention, “About 75 million adults (29%) have high blood pressure—that's 1 of every 3 adults. High blood pressure costs the nation $46 billion each year. More than 360,000 American deaths in 2013 included high blood pressure as a primary or contributing cause. That is almost 1,000 deaths each day.”

According to Center for Disease Control and Prevention, Coronary heart disease is the most common type of heart disease, killing about 365,000 people in 2014.

According to the Center for Disease Control and Prevention, “Stroke is the fifth leading cause of death in the United States, killing more than 130,000 Americans each year, that is 1 of every 20 deaths. Every year about 795,000 people in the United States have a stroke. About 610,000 of these are first or new strokes; 185,000 are recurrent strokes.”

According to the Center for Disease Control and Prevention, “Cholesterol, 71 million American adults (33.5%) have high low-density lipoprotein (LDL), or “had cholesterol.”

www.cdc.gov

Obesity—“Almost 13 million (16.9%) of U.S. children ages 2 to 19 are obese. Nearly one in three (31.8%) U.S. children (23.9%) ages 2 to 19 are overweight or obese. More than one-third about (35%) of U.S. adults is obese (more than 78 million adults).”

“Garlic contains a compound called Allicin, which has potent medicinal properties, it is highly nutritious, and very few calories.” https://authoritynutrition.com

Eleven benefits of garlic: “Contain the medicinal property (Allicin), highly nutritious, combat sickness, including common cold, reduce blood pressure, improves cholesterol levels, garlic contains Antioxidants that may help prevent Alzheimer's disease and Dementia, garlic may help you live longer, Athletic performance can be improved with garlic supplementation, eating garlic can help detoxify heavy metals in the body, garlic may improve bone health, and garlic is easy to include in your diet and tastes absolutely delicious.”

https://authoritynutrition.com

7 Medicinal Raw Garlic Benefits:

1. Garlic for heart disease
2. Garlic for cancer
3. Garlic for high blood pressure
4. Garlic for colds and infections
5. Garlic for lowering High low-density lipoprotein (LDL)
6. Garlic for Alzheimer's disease and Dementia

### 7. Garlic for Diabetes

https://draxe.com/7-raw-garlic-benefits

Are Statin drugs safe? “There have been reports of the drug causing side effects that include an increased risk of hemorrhagic stroke, muscle pain and weakness and diabetes, causing acceptance of the drug to be split.” wwwcnn.com/2016/09/08/health/study

What are some of the side effects of Statin drugs? “The two major side effects—both of which occur relatively rarely—are liver failure and skeletal muscle damage. The muscle change is a severe type of Myopathy called Rhabdomyalysis. Rhabdomyolysis usually begins as muscle pain and can worsen to such an extent that the patient loses all muscle cells, experiences kidney failure, or dies. The condition is more common when Statins are used in combination with other drugs that raise the Statin levels in the blood.” www.medicalnewstoday.com/articles/8274

Supplements loses its effectiveness because the garlic is cooked. “Odorless garlic pills are usually cooked, and thus inactivate the enzyme that breaks down Alliin in order to make Allicin. On occasion, an odor masking compound such as chlorophyll is added instead of being heated, though this does not appear to be effective in reducing odor.” www.livestrong.com

Side effects of garlic, “bad breath, upset stomach, bloating, do not take garlic if you take a blood-thinning medication.” www.healtheating.sfgate.com Garlic acts as a natural blood thinner.

### SUMMARY OF INVENTION

This invention is intended to be a natural and inexpensive alternative to garlic supplements and Statin drugs. “Allicin is the most powerful medicinal compound derived from garlic and provides the greatest reputed health benefits.” Garlic must be consumed in the raw to obtain the best benefit. Allicin does not occur in “Ordinary” garlic, it is produced, when garlic is finely chopped, chewed or crushed.” www.garlic-central.com.

This invention will make it easier for consumers to consume raw garlic with little garlic taste or odor, therefore, helping us to lower our metabolic risk factors, such as obesity, high blood pressure, high low-density lipoprotein (LDL), heart disease, diabetes, and strokes. Garlic has been around for years, helping people maintain optimum health. This invention will allow us to have our garlic on the go.

### DETAILED DESCRIPTION OF DRAWINGS

“Not Applicable”

### DETAILED DESCRIPTION OF THE INVENTION

Delicious shakes and smoothies with garlic being the key ingredient; which can contribute to optimum health. Garlic works to help lower our metabolic risk factors, by helping to lower high low-density lipoprotein, high blood pressure, and help maintain a healthy blood glucose level; it could even help with weight loss because of the fiber.

These garlic shakes and smoothies could possibly be a natural alternative to Garlic Supplements and Statin drugs; which can help people who can't tolerate the Statin drugs, for lowering high low-density lipoprotein (LDL). (Article Re: Statin Drugs posted by the Washington Post on Apr. 3, 2016. www.cbsnews.com/news/study-confirm.

This invention can be beneficial to everyone, even children of age. Anyone who eats garlic, can now take the easy way to optimum health, by drinking these delicious garlic shakes and smoothies. The mint and other extracts minimize the garlic taste and odor.

Garlic is a plant in the Allium (onion) family closely related to onions, shallots, leeks, chives, and scallions; these can be substituted in the garlic recipe.

“Allicin is the most powerful medicinal compound derived from garlic and provides the greatest reputed health benefits. Allicin does not occur in “Ordinary” garlic, it is produced when garlic is finely chopped, chewed or crushed.” www.garlic-central.com. Allium Vegetables Benefits (m-jnci.oxfordjournals.org). Proven Health Benefits for garlic (www.rd.com/health/beauty/13) Health Benefits of Garlic Fall 2003 (eatingwell.com).

### Delicious Garlic Shakes and Smoothies

Ingredients:
(1) Garlic: Cloves, bulbs, chopped garlic, minced garlic, crushed garlic, powder garlic, garlic juice, and garlic leaves, dried garlic, roasted garlic, and cooked garlic.
(2) Garlic substitutes: Onions, shallots, leeks, chives, scallions, and any other member of the onion family.
(3) Fruit: Fresh, frozen, canned, dried or preserved.
(4) Citrus Juice: Including, citrus meat, skin, peel, and rind.
(5) Extracts and flavorings.
(6) Sweeteners.
(7) Liquids: Milk, water, juice, juice drinks.
(8) Herbs: Fresh or dried mint leaves, parsley sprigs, basil leaves.

### Steps to Making the Delicious Garlic Shakes and Smoothies

1. Between ½-1 raw garlic clove.
2. Between ½-¾ cup strawberries (or other fruit).
3. Between 1-3 drops of mint extract (or other extracts) or 3-4 fresh mint leaves or ½ teaspoon dried mint leaves.
4. Between 1-3 fresh basil leaves or ½ teaspoon dried basil leaves.
5. Between 1-3 fresh parsley sprigs or ½ teaspoon dried parsley.
6. Between ½-1 teaspoon nutritional yeast.
7. Between 1-2 tablespoon of lemon juice (or other citrus juices).
8. Between 1-3 teaspoon sweetener.
9. Between 12-16 ounces liquid (water, juice, milk, juice drinks).
10. Between ½-1 teaspoon ground flax seed.
11. Put all the ingredients into a blender and blend until smooth, serve chilled.

Note: For smoothies use fruit from its frozen state, and use fresh or slightly frozen fruit for the shakes. The final result is an easier way to consume garlic in the raw, and an easier way to help improve our metabolic risk factors, and be on our way to a healthier lifestyle. Garlic can help!

### RESOURCES

www.authoritynutrition.com
www.whfoods.com
www.naturalsociety.com
www.garlic-central.com

1. Delicious Garlic Shakes and Smoothies comprising of:
a. Between ½-1 raw garlic clove.
b. Between ½-¾ cup strawberries (or other fruit).
c. Between 1-3 drops of mint extract (or other extracts) or 3-4 fresh mint leaves or ½ teaspoon dried mint leaves.
d. Between 1-3 fresh basil leaves or ½ teaspoon dried basil leaves.
e. Between 1-3 fresh parsley sprigs or ½ teaspoon dried parsley.
f. Between ½-1 teaspoon nutritional yeast.
g. Between 1-2 tablespoon of lemon juice (or other citrus juices).
h. Between 1-3 teaspoon sweetener.
i. Between 12-16 ounces liquid (water, juice, milk, juice drinks).
j. Between ½-1 teaspoon ground flax seed.
k. Put all the ingredients into a blender and blend until smooth, creating a delicious garlic shake or smoothie, serve chilled.

2. The Delicious Garlic Shakes and Smoothies in claim 1 further comprising of:
a. Garlic: Cloves, bulbs, chopped garlic, minced garlic, crushed garlic, powder garlic, and garlic juice, and garlic leaves, dried garlic, roasted garlic, and cooked garlic.
b. Garlic substitutes: Onions, shallots, leeks, chives, scallions, and any other member of the onion family.
c. Fruit: Fresh, frozen, canned, dried or preserved.
d. Citrus Juice: Including, citrus meat, skin, peel, and rind.
e. Extracts and flavorings.
f. Sweeteners.
g. Liquids: Milk, water, juice, juice drinks.
h. Herbs: Fresh or dried mint leaves, parsley sprigs, basil leaves.
